(19) United States
(12) Patent Application Publication
(10) Pub. No.: US 2002/0141702 A1
(43) Pub. Date: Oct. 3, 2002

(54) Diffraction grating, optical element and manufacturing methods of the same

(76) Inventors: Seishi Ojima, Takatsuki-shi (JP); Miyuki Teramoto, Takatsuki-shi (JP); Takuji Hatano, Suita-shi (JP)

Correspondence Address: Barry E. Bretschneider, Morrison & Foerster LLP, Suite 5500, 2000 Pennsylvania Avenue, N.W., Washington, DC, 20006-1888, US

(21) Appl. No.: 10/103,717

(22) Filed: Mar. 25, 2002

(30) Foreign Application Priority Data
Mar. 27, 2001 (JP) 2001-089177

(51) Int. Cl. G02B 6/34; G02B 5/18

(52) U.S. Cl. 385/37; 359/566

(57) ABSTRACT

An optical device including a diffraction grating of high reflectivity with respect to wavelengths of light to be extracted provides a diffraction grating and an optical element with a large range of varying wavelengths of light to be extracted. An ultraviolet light having a pattern of a prescribed pitch is projected to a precursor of a polyimide. The precursor is polymerized after the ultraviolet light is projected to obtain a diffraction grating made of polyimide. The diffraction grating has a high reflectivity on an intended light wavelength.

### CROSS-REFERENCE TO RELATED APPLICATION

This application is based on Japanese Patent Application No. 2001-089177 filed in Japan on Mar. 27, 2001, the entire content of which is hereby incorporated by reference.

### BACKGROUND OF THE INVENTION

1. Field of the Invention

The present invention relates to a diffraction grating for extracting signals of prescribed wavelengths from wavelength multiplex signals, an optical element such as a wavelength selecting filter employed in a device for wavelength multiplex operation, and methods for manufacturing these elements.

2. Description of the Related Art

A conventional wavelength selecting filter employed for wavelength multiplex operation includes a waveguide path for wave-guiding incident light and is arranged in that a diffraction grating is formed within a core layer of the waveguide path that is sandwiched between clad layers. The clad layer is formed by film-forming quartz while doping fluorine or the like, and the core layer is formed by film-forming quartz. In this manner, a refractive index of the core layer will be larger than that of the clad layer such that light that is made incident into the core layer will be confined and wave-guided.

Grooves of prescribed pitches are formed onto the core layer such that materials for forming the clad layer are laminated onto the grooves. Thus, materials comprising the clad layer and materials comprising the core layer will be arranged at prescribed pitches in a waveguide direction. With this arrangement, a diffraction grating of refractive index modulating type in which the refractive indices vary at prescribed pitches in a waveguide direction is formed.

In case light is made incident into the waveguide path upon wavelength multiplexing, the light will be wave-guided through the core layer. Light of a prescribed wavelength will be reflected by the diffraction grating in accordance with the pitch and refractive index of the diffraction grating, and light of different wavelengths will pass through the diffraction grating. With this arrangement, it is possible to extract light of a prescribed wavelength.

However, according to the above conventional wavelength selecting filter, wavelengths of light that can be extracted are dependent on the pitch and refractive index of the diffraction grating. Thus, for extracting light of different wavelengths in accordance with various conditions, pitches of the diffraction grating needed to be made variable upon mechanically expanding and shrinking the wavelength selecting filter. This would lead to a drawback of making the communication device complicated and large-sized.

It would be possible to provide a temperature varying element such as a Peltier element proximate to the diffraction grating. More particularly, the temperature of the diffraction grating is elevated through the temperature varying element for varying the refractive index of quartz and extracting light of different wavelengths. However, since a thermo-optical constant dn/dT (n: refractive index, T: temperature) of quartz is small in such a method, the range of the wavelengths of intended light is small. Thus, a plurality of wavelength selecting filters needed to be provided to cope with a plurality of wavelengths, and would thus lead to a drawback of upsizing the communication device.

### SUMMARY OF THE INVENTION

The present invention aims to provide an optical device including a diffraction grating of high reflectivity with respect to wavelengths of light to be extracted and an optical element using the same. The present invention also aims to easily provide a diffraction grating and an optical element which range of varying wavelengths of light to be extracted is large. The present invention further provides manufacturing methods of a diffraction grating and an optical element through which a diffraction grating and an optical element which range of varying wavelengths of light to be extracted is large can be easily obtained.

To achieve at least one of the objects mentioned above, a manufacturing method of a diffraction grating comprises the steps of projecting an ultraviolet light having a pattern of a prescribed pitch to a precursor of a polyimide, and polymerizing the precursor after the projecting step. According to the manufacturing method mentioned above, a diffraction grating made of the polyimide can be obtained. Since difference in refractive indices of the diffraction grating thus made can be large, and, therefore, the diffraction grating having a high reflectivity in an intended light wavelength can be obtained.

In the manufacturing method mentioned above, the polymerization of the precursor may be carried out by baking the precursor at or higher than a polymerization temperature of the precursor.

In the manufacturing method mentioned above, a step of preparing the precursor on a clad material may be carried out before the projecting step. As for the clad material, a polyimide having a lower refractive index than the polyimide used for the diffraction grating may be used. The preparing step may comprise the steps of coating a mixture of the precursor and a solvent on the clad material, and vaporizing the solvent from the mixture. Vaporization of the solvent may be achieved by heating the mixture to a temperature lower than the polymerization temperature.

According to another aspect of the present invention, a manufacturing method of an optical element that has a waveguide diffraction grating comprises the steps of projecting an ultraviolet light having a pattern of a prescribed pitch to a precursor of a polyimide, and polymerizing the precursor after the projecting step.

According to further aspect of the present invention, a diffraction grating is made of a polyimide, and has been prepared by projecting an ultraviolet light having a pattern of a prescribed pitch to a precursor of the polyimide and thereafter polymerizing the precursor. Since the diffraction grating prepared by the process mentioned above has a large difference in refractive indices of the diffraction grating, a high reflectivity in an intended light wavelength can be achieved.

According to still further aspect of the present invention, an optical element comprises a waveguide diffraction grating made of a polyimide, said waveguide diffraction grating being prepared by projecting an ultraviolet light having a pattern of a prescribed pitch to a precursor of the polyimide and thereafter polymerizing the precursor. According to the structure mentioned above, difference in refractive indices of the diffraction grating can be large, and therefore, an optical element having a high reflectivity in an intended light wavelength can be obtained.

The optical element having the structure mentioned above may further comprise a temperature controller for controlling a temperature of the waveguide diffraction grating. The temperature controller element may comprise a Peltier element. By controlling the temperature of the waveguide diffraction grating, the intended wavelength can be varied, and therefore, an optical element having a tunable waveguide diffraction grating can be obtained. Since the polyimide has a large thermo-optical constant, the tunable wavelength range can be wide.

### BRIEF DESCRIPTION OF THE DRAWINGS

These and other objects, advantages and features of the invention will become apparent from the following description thereof taken in conjunction with the accompanying drawings in which:

FIG. 1 is a plan view illustrating an optical device employing an optical element according to an embodiment of the present invention;

FIG. 2 is a plan view illustrating another optical device employing an optical element according to an embodiment of the present invention;

FIGS. 3(a) to 3(e) are front views illustrating a manufacturing method of the optical element according to an embodiment of the present invention;

FIGS. 4(a) and 4(b) are a side view and a plan view illustrating processes for forming a diffraction grating according to the manufacturing method of the optical element according to an embodiment of the present invention; and

FIG. 5 is a plan view illustrating a patterning process of a waveguide path according to the manufacturing method of the optical element according to an embodiment of the present invention.

### DESCRIPTION OF THE PREFERRED EMBODIMENTS

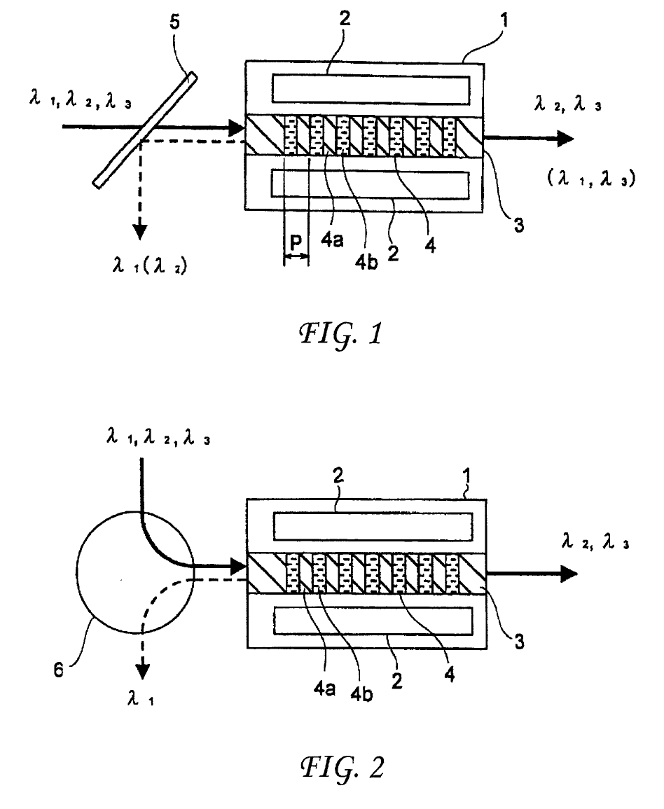

An embodiment of the present invention will hereinafter be explained with reference to the drawings. FIG. 1 is a plan view illustrating an optical device employing a wavelength selecting filter that serves as an optical element according to an embodiment. The wavelength selecting filter 1 is comprised of a waveguide path made of polyimide. A diffraction grating 4 of refractive index modulating type is formed within a core layer 3 of the waveguide path with media 4a, 4b of different refractive indices being arranged at prescribed pitches. As it will be discussed later in details, the medium 4b is formed upon projecting ultraviolet light onto the medium 4a for varying its refractive index.

A Peltier element 2 is integrally formed on a side portion of the core layer 3. The Peltier element 2 is heated or cooled, which depends on the direction of current, through supply of current for varying the temperature of the diffraction grating 4.

A half mirror 5 is disposed lateral of the wavelength selecting filter 1. Upon incidence of wavelength multiplex signals in which light of wavelengths λ₁, λ₂ and λ₃ are multiplexed into the core layer 3 through the half mirror 5, such light will be wave-guided through the core layer 3. Light of wavelength λ₁ will be reflected through the diffraction grating 4, and light of λ₂ and λ₃ will be transmitted. In this manner, light of λ₁ will be projected out from the incident portion so as to be reflected by the half mirror 5 and to be extracted.

The wavelength of reflected light is determined by the refractive indices of the media 4a, 4b and the pitch P of the diffraction grating 4. Since the media 4a, 4b are made of polyimide, their thermo-optical constants dn/dT (n: refractive index, T: temperature) are larger than that of quartz by approximately one digit, and their refractive indices are easily varied through elevation of the temperature.

Thus, upon supply of current to the Peltier element 2, the refractive indices of the media 4a, 4b of the diffraction grating 4 are varied so that light of λ₂ can be reflected and extracted while light of wavelengths λ₁ and λ₃ are transmitted even though the difference between wavelengths λ₁ and λ₂ is large as illustrated in the bracket in the drawing. With this arrangement, it is possible to obtain a wavelength selecting filter 1 with which wavelengths of intended light can be varied within a large range.

As illustrated in FIG. 2, it is alternatively possible to employ a circulator 6 instead of the half mirror 5 through which a wavelength multiplex signal is made incident into the optical element 1 for extracting light having a prescribed wavelength λ₁. It should be noted that it is not necessary to integrate the Peltier element 2 with the wavelength selecting filter 1 but it may be disposed proximate to the wavelength selecting filter 1. It is more desirable to provide a temperature sensor for detecting a temperature of the diffraction grating 4 for accurately controlling wavelengths of light that is to be extracted through the diffraction grating 4. More particularly, it is further desirable to provide a mechanism for detecting wavelengths of light to be extracted themselves.

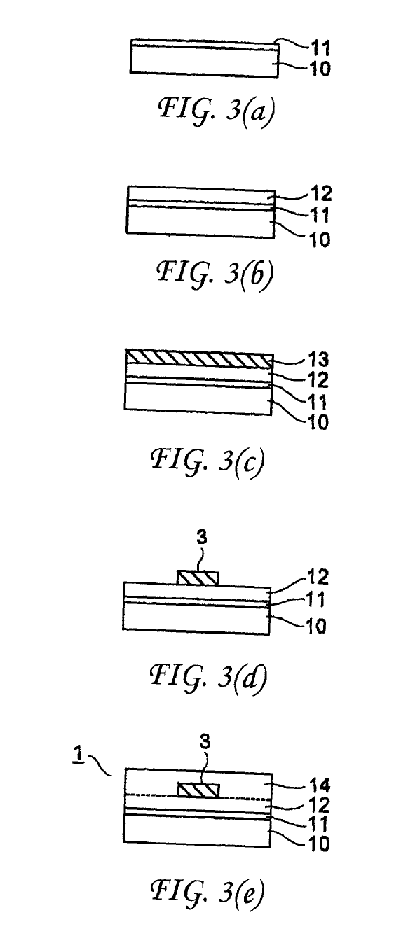

A manufacturing method of the optical element 1 will now be explained with reference to FIGS. 3(a) to (e), 4(a), (b) and 5. As illustrated in FIG. 3(a), a coupler 11 was applied through a spinner or similar onto a substrate 10 made, for instance, of silicon and was baked for 30 minutes at 150° C. In the present embodiment, OPI-coupler manufactured by Hitachi Kasei was employed. The coupler 11 is used for improving adhesive strength between the silicon and polyimide that comprises a lower clad 12 as will be discussed later, and may also be omitted in case it is possible to secure sufficient adhesive strength between the substrate 10 and polyimide.

In FIG. 3(b), a precursor of polyimide was applied by using a spinner or similar which was baked at prescribed baking conditions for forming a lower clad layer 12 made of polyimide. In the present embodiment, the precursor of polyimide for forming the lower clad layer 12 was N2305-50 manufactured by Hitachi Chemical Co., Ltd. (Tokyo, Japan).

In FIG. 3(c), a precursor through which polyimide had a larger refractive index than that of the lower clad layer 12 was applied onto the lower clad layer 12 by using a spinner or similar. The same was baked at prescribed baking conditions for forming a core layer 13 made of polyimide. In the present embodiment, the precursor of polyimide for forming the core layer 13 was N3305-50 manufactured by Hitachi Chemical Co., Ltd.

At this time, the diffraction grating 4 was formed within the core layer 13. The precursor of polyimide was polyimidized at approximately 250° C. For this purpose, baking was performed for 120 minutes at 90° C., and thus a temperature lower than 250° C., after applying the precursor for vaporizing a solvent and curing the precursor. Thereafter, a mask 16 formed with concaves and convexes at prescribed pitches was disposed above the cured film 13′ of the precursor and ultraviolet light of 254 nm was projected from above as indicated by arrow B for 1 hour at 40 mW/cm² as illustrated in FIG. 4(a).

In the present embodiment, the mask 16 was formed of a quartz substrate wherein concaves and convexes were formed on a surface of the quartz substrate at pitches of 1,020 nm. Ultraviolet light transmitting through the mask 16 was diffracted by the concaves and convexes, and ultraviolet light was projected onto a surface of the cured film 13′ at pitches of 510 nm through +1 ordered diffracted light and −1 ordered diffracted light.

Upon performing baking at 90° C. for 120 minutes, at 160° C. for 30 minutes, at 250° C. for 30 minutes and at 395° C. for 90 minutes in this order, the precursor was polyimidized such that a core layer 13 made of polyimide was formed as illustrated in the plan view of FIG. 4(b).

Since polyimide is characterized in that its refractive index was variable upon projection of ultraviolet light, a medium 4b having a different refractive index is formed within the core layer 13. In the present embodiment, a refractive index of a portion (4a) onto which no ultraviolet light has been projected was 1.5294 with respect to TE waves of a wavelength of 1,550 nm while a refractive index of a portion onto which ultraviolet has been projected (4b) was 1.5321 with respect to the same wavelength. It was accordingly possible to form a diffraction grating 4 in which different media 4a, 4b with a difference between their refraction indices being 0.0027 were aligned at a prescribed pitch P (=510 nm).

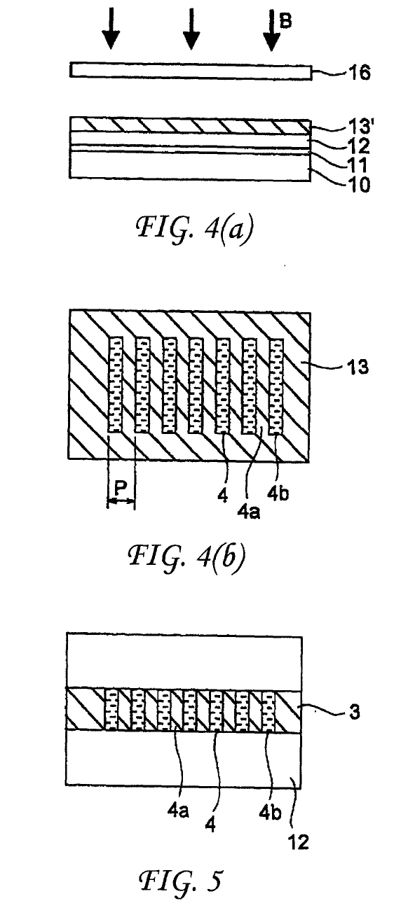

A photoresist was then applied onto the core layer 13 which was patterned into a prescribed width and underwent RIE. With this arrangement, a core layer 3 having a prescribed width is formed as illustrated in FIGS. 5 and 3(d). In FIG. 3(e), a precursor of polyimide similar to that of the lower clad layer 12 was applied by using a spinner or similar and was baked at prescribed baking conditions for forming an upper clad layer 14 made of polyimide.

In this manner, the wavelength selecting filter 1 including the diffraction grating 4 within the core layer 3 could be obtained. Since the core layer 3 is sandwiched between the lower clad layer 12 of small refractive index and the upper clad layer 14, incident luminous flux could be confined in the core layer 3 for wave-guiding. The temperature of the diffraction grating 4 could be varied as illustrated in the above-discussed FIG. 1 upon adhering the Peltier element 2 onto the upper clad layer 14.

According to the manufacturing method of an optical element (wavelength selecting filter) of the present embodiment, media 4a, 4b of different refractive indices could be easily formed in a periodic manner upon projecting ultraviolet light onto a thin film made of a precursor of polyimide (cured layer 13′) through a mask 16. The refractive index of polyimide may also be varied upon projecting electrons onto the cured layer 13′. However, since it is necessary to scan the electrons for forming a periodic structure which takes time for processing, the method of the present embodiment is more desirable in which ultraviolet light is projected by using a mask.

A comparative example will be explained in which a diffraction grating was formed upon projecting ultraviolet light onto a core layer 13 after polyimidizing of a precursor. Such a manufacturing method differs in the following points though a part of its processes is common to that of the manufacturing method of the above embodiment. More particularly, a precursor of polyimide (N3305-20 manufactured by Hitachi Chemical Co., Ltd.) was baked at 90° C. for 120 minutes, at 160° C. for 30 minutes, at 250° C. for 30 minutes and at 395° C. for 90 minutes in the above-described FIG. 3(c) whereupon ultraviolet light of 254 nm was projected for 1 hour at 40 mW/cm² through a mask 16, similar to the above manner. It was consequently found that a refractive index of a portion (4a) onto which no ultraviolet light has been projected was 1.5294 with respect to TE waves of a wavelength of 1,550 nm, similar to the above case, while a refractive index of a portion onto which ultraviolet has been projected (4b) was 1.5299 with respect to the same wavelength. It was accordingly formed a diffraction grating 4 in which different media 4a, 4b with a difference between their refraction indices being 0.0005 are aligned at a prescribed pitch P.

Upon comparison of the diffraction grating manufactured according to the manufacturing method of the above-described embodiment with the diffraction grating manufactured according to the manufacturing method of the comparative example, it can be understood that the diffraction grating 4 obtained through the manufacturing method of the above-described embodiment exhibited a larger difference in refractive indices and high reflectivity with respect to extracted wavelengths, and was thus the more desirable one.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. A manufacturing method of a diffraction grating comprising the steps of:
(a) projecting an ultraviolet light having a pattern of a prescribed pitch to a precursor of a polyimide; and
(b) polymerizing the precursor after the step (a).

2. A manufacturing method as claimed in claim 1, in the step (b), the polymerization of the precursor is carried out by baking the precursor at or higher than a polymerization temperature of the precursor.

3. A manufacturing method as claimed in claim 1, further comprising the step of:
(c) preparing the precursor on a clad material before the step (a).

4. A manufacturing method as claimed in claim 3, wherein a polyimide having a lower refractive index than the polyimide used for the diffraction grating is used for the clad material.

5. A manufacturing method as claimed in claim 3, the step (c) comprising the steps of:
(c-1) coating a mixture of the precursor and a solvent on the clad material; and
(c-2) vaporizing the solvent from the mixture.

6. A manufacturing method as claimed in claim 5, wherein, in the step (c-2), the vaporization of the solvent is achieved by heating the mixture to a temperature lower than the polymerization temperature.

7. A manufacturing method of an optical element that has a waveguide diffraction grating comprising the steps of:
(a) projecting an ultraviolet light having a pattern of a prescribed pitch to a precursor of a polyimide; and
(b) polymerizing the precursor after the step (a).

8. A manufacturing method as claimed in claim 7, in the step (b), the polymerization of the precursor is carried out by baking the precursor at or higher than a polymerization temperature of the precursor.

9. A manufacturing method as claimed in claim 7, further comprising the step of:
(c) preparing the precursor on a clad material before the step (a).

10. A manufacturing method as claimed in claim 9, wherein a polyimide having a lower refractive index than the polyimide used for the diffraction grating is used for the clad material.

11. A manufacturing method as claimed in claim 9, the step (c) comprising the steps of:
(c-1) coating a mixture of the precursor and a solvent on the clad material; and
(c-2) vaporizing the solvent from the mixture.

12. A manufacturing method as claimed in claim 11, wherein, in the step (c-2), the vaporization of the solvent is achieved by heating the mixture to a temperature lower than the polymerization temperature.

13. A diffraction grating that is made of a polyimide, and has been prepared by projecting an ultraviolet light having a pattern of a prescribed pitch to a precursor of the polyimide and thereafter polymerizing the precursor.

14. An optical element comprising a waveguide diffraction grating made of a polyimide, said waveguide diffraction grating being prepared by projecting an ultraviolet light having a pattern of a prescribed pitch to a precursor of the polyimide and thereafter polymerizing the precursor.

15. An optical element as claimed in claim 14, further comprising a temperature controller for controlling a temperature of the waveguide diffraction grating.

16. An optical element as claimed in claim 15, wherein the temperature controller element comprises a Peltier element.
